(19) United States
(12) Patent Application Publication
(10) Pub. No.: US 2026/0284531 A1
(43) Pub. Date: Sep. 24, 2026

(54) PERSONALIZED SOUNDTRACK FOR GAME-PLAY VIDEO

(71) Applicant: Sony Interactive Entertainment Inc., Tokyo (JP)

(72) Inventors: Syrsha Harvey, San Francisco, CA (US); Dilip Krishnamoorthi, Daly City, CA (US)

(73) Assignee: Sony Interactive Entertainment Inc., Tokyo (JP)

(21) Appl. No.: 19/083,265

(22) Filed: Mar. 18, 2025

(51) Int. Cl. A63F 13/54; G06F 16/635; G06V 20/40; G11B 27/00; G11B 27/036; G11B 27/10

(52) U.S. Cl. CPC A63F 13/54; G06F 16/635; G06V 20/41; G06V 20/47; G11B 27/005; G11B 27/036; G11B 27/10

(57) ABSTRACT

A video segment of video game play by a user can be augmented by the addition of a personalized soundtrack using one or more audio tracks (e.g., songs or other music tracks) that are automatically selected from a personal audio library of the user. Selection can be based on similarity between properties associated with the audio track and attributes of the video segment. The selected audio track(s) can be mixed with game sounds in the video segment.

### BACKGROUND

This disclosure relates generally to content creation related to video games and in particular to generating a personalized soundtrack for game-play videos.

Video games can be an incredibly immersive form of entertainment. Whether played alone or in groups over the internet, video games can be challenging and engaging. Many players also enjoy capturing and sharing video clips of game play, including clips that demonstrate the player's prowess (or amusing lack thereof) or document an in-game achievement. To enhance the entertainment value, users may edit the video clips in various ways.

### SUMMARY

According to some embodiments, a video clip (or “video segment”) can be augmented, or enhanced, by the addition of a personalized soundtrack using one or more audio tracks (e.g., songs or other music tracks) that are automatically selected from a personal audio library of the user. Selection can be based on similarity between properties associated with the audio track and attributes of the video segment. The selected audio track(s) can be mixed with game sounds in the video segment.

According to some embodiments, a computer-implemented method can comprise: receiving a recorded video segment of game play by a user of a video game system; determining one or more attributes of the recorded video segment; selecting, from a personal audio library associated with the user, an audio track to accompany the recorded video segment, wherein each audio track in the personal audio library has an associated set of properties and wherein the selection of the audio track is based at least in part on a similarity between the one or more attributes of the recorded video segment and the set of properties of the audio tracks; and mixing at least a portion of the selected audio track into the recorded video segment to produce an augmented video segment.

According to some embodiments a system can comprise a memory and a processor coupled to the memory. The processor can be configured to: receive a recorded video segment of game play by a user of a video game system; determine one or more attributes of the recorded video segment; select, from a personal audio library associated with the user, an audio track to accompany the recorded video segment, wherein each audio track in the personal audio library has an associated set of properties and wherein the selection of the audio track is based at least in part on a similarity between the one or more attributes of the recorded video segment and the set of properties of the audio tracks; and mix at least a portion of the selected audio track into the recorded video segment to produce an augmented video segment.

According to some embodiments, a computer-readable storage medium can have stored therein program code instructions that, when executed by a processor in a computer system, cause the processor to perform a method comprising: receiving a recorded video segment of game play by a user of a video game system; determining one or more attributes of the recorded video segment; selecting, from a personal audio library associated with the user, an audio track to accompany the recorded video segment, wherein each audio track in the personal audio library has an associated set of properties and wherein the selection of the audio track is based at least in part on a similarity between the one or more attributes of the recorded video segment and the set of properties of the audio tracks; and mixing at least a portion of the selected audio track into the recorded video segment to produce an augmented video segment.

In these and other embodiments, determining the one or more attributes of the recorded video segment can include determining a pace of the game play in the recorded video segment, and selecting the audio track can include identifying an audio track in the personal audio library that has a tempo that corresponds to the pace.

In these and other embodiments, determining the one or more attributes of the recorded video segment can include inferring, from an automated analysis of video data in the recorded video segment, a sentiment associated with the recorded video segment, and selecting the audio track can include identifying an audio track in the personal audio library that has a corresponding sentiment.

In these and other embodiments, determining the one or more attributes of the recorded video segment can include generating, using a video analysis tool, a narration describing video content of the recorded video segment, and selecting the audio track can include identifying an audio track in the personal audio library that has lyrics with similarity to the narration.

In these and other embodiments, selecting the audio track can be performed using a machine-learning model that has been trained to generate a similarity score from a set of attributes of a video segment and a set of properties of an audio track. The selection can be based on comparing the similarity scores for a plurality of candidate audio tracks.

In these and other embodiments, the one or more attributes of the recorded video segment can include one or more of: a keyword associated with a title of a game being played in the recorded video segment; a frame rate of the recorded video segment; a frequency or speed of player inputs to a controller during the game play; a sentiment tag included in metadata of the recorded video segment; an automatically-generated description or narration of the recorded video segment; a kinetic quality of the recorded video segment; or an esthetic quality of the recorded video segment.

In these and other embodiments, the one or more properties of the audio track can include one or more of: a genre of the audio track; a tempo of the audio track; dynamics of the audio track; a prominent instrument in the audio track; a lyric in the audio track; or a tag indicating an esthetic quality of the audio track.

In these and other embodiments, the personal audio library can be maintained at a music streaming service, and a processor can communicate with the music streaming service to obtain a list of audio tracks in the personal audio library of the user.

In these and other embodiments, the associated set of properties for one or more audio tracks from the personal audio library can be determined by accessing a database of properties of audio tracks.

In these and other embodiments, mixing at least a portion of the selected audio track into the recorded video segment can include combining the portion of the selected audio track with a game-play audio track of the recorded video segment.

In these and other embodiments, mixing at least a portion of the selected audio track into the recorded video segment can include modifying the portion of the selected audio track to align in time with an event in the recorded video segment.

In these and other embodiments, the recorded video segment can include audio data representing in-game sound, and mixing at least a portion of the selected audio track into the recorded video segment to produce an augmented video segment can include combining the portion of the selected audio track with the audio data from the recorded video segment.

In these and other embodiments, mixing at least a portion of the selected audio track into the recorded video segment to produce an augmented video segment can include selecting a particular portion of the selected audio track to be mixed with an audio component of the recorded video segment.

In these and other embodiments, selecting the audio track to accompany the recorded video segment can include: constructing a preliminary list of audio tracks from the personal audio library; obtaining the associated set of properties for each audio track in the preliminary list of audio tracks; computing a score for each audio track in the preliminary list of audio tracks, wherein the score is based on a comparison between the one or more attributes of the recorded video segment and the set of properties for the audio track; selecting, from the preliminary list of audio tracks, a set of candidate tracks based on the scores; ranking the candidate tracks in the set of candidate tracks; and making a final selection of the audio track to accompany the recorded video segment based on the ranking of the candidate tracks.

The following detailed description, together with the accompanying drawings, will provide a better understanding of the nature and advantages of the claimed invention.

### BRIEF DESCRIPTION OF THE DRAWINGS

FIG. 1 illustrates an example of a player interacting with an illustrative gaming system according to some embodiments.

FIG. 2 shows a simplified block diagram further illustrating a system for augmenting a video segment with a personalized soundtrack according to some embodiments.

FIG. 3 shows a flow diagram of a process for augmenting a video segment with a personalized soundtrack according to some embodiments.

FIG. 4 is a flow diagram showing additional details of audio track selection according to some embodiments.

FIG. 5 shows a graphical user interface according to some embodiments.

FIG. 6 shows a flow diagram of an interactive process for augmenting a video segment with a personalized soundtrack according to some embodiments.

FIG. 7 shows a simplified block diagram of a hardware system suitable for implementing a computer system according to some embodiments.

### DETAILED DESCRIPTION

The following description of exemplary embodiments is presented for the purpose of illustration and description. It is not intended to be exhaustive or to limit the claimed embodiments to the precise form described, and persons skilled in the art will appreciate that many modifications and variations are possible. The embodiments have been chosen and described in order to best explain their principles and practical applications to thereby enable others skilled in the art to best make and use various embodiments and with various modifications as are suited to the particular use contemplated.

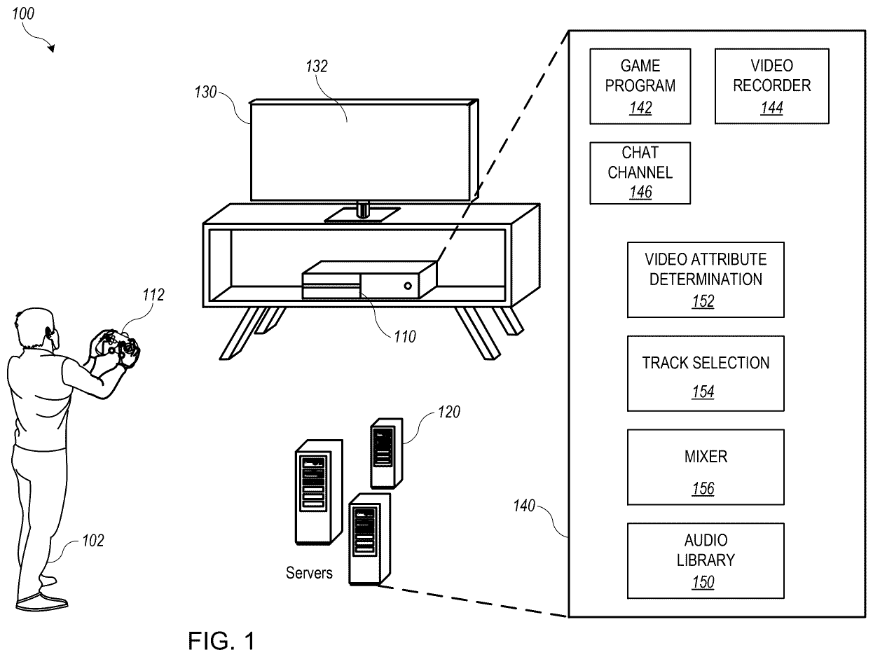

FIG. 1 illustrates an example of a player interacting with an illustrative gaming system 100 according to some embodiments. Gaming system 100 can be capable of augmenting a recorded video game segment with a soundtrack personalized to the player. In the illustrated example, a player 102 (also referred to as a “user”) can interact with a gaming console 110 using a controller 112. Controller 112 can communicate with gaming console 110 via a wired or wireless connection. Gaming console 110 can display game images on a screen 132 of a monitor 130. Gaming console 110 can also play game sounds, e.g., using one or more speakers (not shown) which can be integrated with monitor 130 or implemented as one or more a separate speaker device. Gaming console 110 can share information with servers 120 via one or more paths comprising wired and wireless links, though in these and other embodiments, gaming console 110 can be or can operate as a standalone device without an internet connection. In other systems, controller 112 and gaming console 110 can be combined into a single device, such as a tablet, phone, portable computer, or other electronic device, though controller 112 can remain a separate component.

Program modules 140 can be allocated and executed on gaming console 110, servers 120, or other computer systems or electronic devices in various ways. In various embodiments, gaming console 110 can execute each or substantially all of the program modules 140, servers 120 can execute each or substantially all of the program modules 140, or responsibility for program modules 140 can be allocated between gaming console 110 (or other electronic device) and servers 120.

In the illustrated example, a game program 142 can be executed on gaming console 110 or servers 120, and player 102 can play the game by observing events on monitor 130 and responsively operating controller 112. A video recorder 144 can be included in gaming console 110 or servers 120. For example, where game program 142 is a solo game executing on gaming console 110, the recording can be done on gaming console 110, while where game program 142 is a multiplayer online game, servers 120 might be better suited to record a video segment. In some instances, game program 142 can be a multiplayer online game program, and a chat channel 146 that enables real-time communication (e.g., voice communication) between players in different locations can be provided using gaming console 110 and servers 120.

According to various embodiments, video recorder 144 can operate during execution of game program 142 to record video segments during game play. Each video segment can include a representation of the image data provided to monitor 130 during a specific interval of time, together with a representation of the corresponding game sounds (e.g., background music, dialog, or sound effects), time-correlated audio from chat channel 146, and associated metadata. Examples of metadata include title of the particular game program 142 being executed; data indicative of the player's position or progress in the game (e.g., time spent, checkpoint(s) completed, location of the player's character in game-world coordinates, or the like); data indicative of the player's operation of controller 112 (e.g., which control was actuated and when); and so on. Depending on implementation, video recorder 144 can operate automatically and/or under user control. For instance, video recorder 144 may automatically create a video segment capturing preset in-game events, such as defeating an enemy, obtaining a reward, or crashing a vehicle. In addition or instead, player 102 may instruct video recorder 144 to start or stop recording, e.g., by providing appropriate input via controller 112.

In some embodiments, player 102 may choose to augment or enhance a particular video segment with a personalized soundtrack. The personalized soundtrack can be automatically generated by selecting one or more audio tracks from an audio library 150 associated with player 102, with the selection being based at least in part on similarities between attributes of the video segment and properties of the selected audio track. Audio library 150 preferably represents a selection of audio tracks that player 102 likes to listen to and may represent audio tracks that player 102 likes to listen to while playing video games. In some embodiments, audio library 150 can be an audio library associated with the player's account on a commercial music streaming service and can be stored on servers 120 or other servers or devices that can communicate with servers 120 and/or game console 110. In various embodiments, audio library 150 can include audio tracks (e.g., songs) or identifiers of audio tracks as well as metadata associated with the audio tracks, such as artist, title, genre, release date, lyrics, tempo (e.g., beats per minute), sentiment or mood (e.g., as determined by automated audio analysis programs and/or human annotators), or the like.

Video attribute determination module 152, track selection module 154, and mixer module 156 can each be executed on gaming console 110 or servers 120 as desired. In operation, video attribute determination module 152 can determine attributes of a video segment. Track selection module 154 can receive the attributes of a video segment from video attribute determination module 152 and query audio library 150 to identify one or more audio tracks whose properties provide a good match to the attributes of the video segment. Quality of a match can be determined, e.g., using algorithmic scoring procedures such as logic trees or using machine-learning models trained to generate a score from a set of input features that includes attributes of the video segment and properties of an audio track. Mixer module 156 can mix a portion (or all) of the audio track identified by track selection module 154 with the audio component of the video segment, thereby generating an augmented (or enhanced) video segment. The augmented video segment can be stored a storage system of gaming console 110 or on storage provided by servers 120, and player 102 can share the augmented video segment with others.

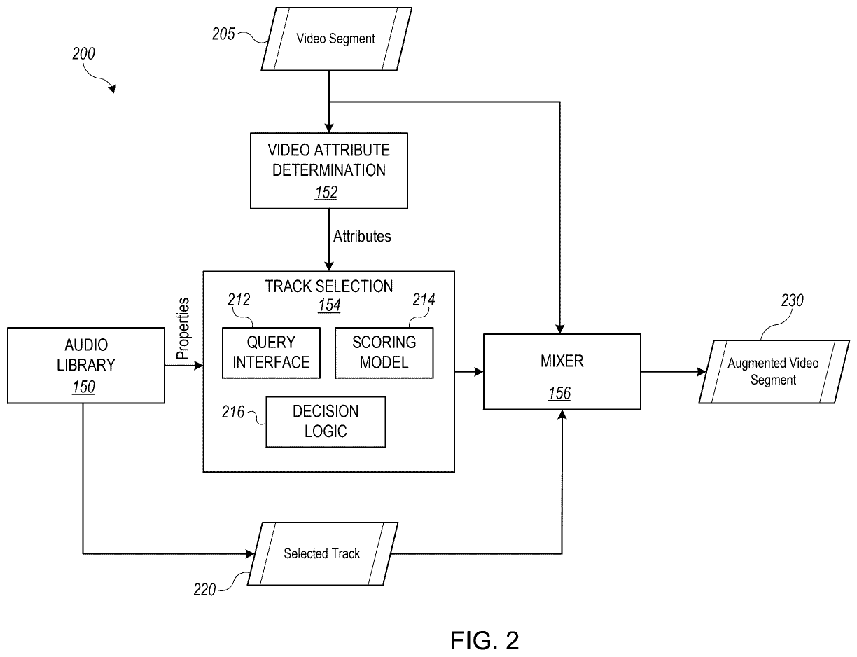

FIG. 2 shows a simplified block diagram further illustrating a system 200 for augmenting a video segment with a personalized soundtrack according to some embodiments. System 200 can include some of program modules 140 of system 100, particularly video attribute determination module 152, audio library 150, track selection module 154, and mixer 156. Different program modules can be executed on the same computer system or different computer systems as desired.

Video attribute determination module 152 can receive a video segment 205. As described above, video segment 205 can be a video segment that was recorded during game play and can include video data (representing the images displayed on screen 132 during game play) and audio data (which can represent sounds produced by game program 142 during game play and/or sounds transmitted via chat channel 146), as well as metadata. Video attribute determination module 152 can determine attributes of the video segment using any combination of the video data, audio data, and metadata. Numerous techniques can be implemented.

As a first example, the metadata may include a title of the game being played in the video segment. In some embodiments, video attribute determination module 152 can access a database of game descriptions, which can be populated with descriptions obtained from the game developer and/or other sources (e.g., reviewers). Video attribute determination module 152 can extract keywords from the game description that may suggest suitable music types (e.g., moods or genres). Examples of keywords that can be extracted as attributes from game descriptions include “relaxing,” “dystopian,” “fast-paced,” “beautiful,” and so on. Keyword extraction can be performed in advance for various game titles, and video attribute determination module 152 can access a lookup table or database at runtime to retrieve keywords associated with a particular game title.

As a second example, some games dynamically adjust the frame rate based on the pace of the game play (or action), with the frame rate being higher where the pace of game play increases (e.g., during a battle) and lower where the pace of game play slows (e.g., when a player's character is exploring in an open world). In some embodiments, video attribute determination module 152 can extract the frame rate from the video data as an attribute.

As a third example, the metadata can include information about when and/or how the controller was operated while the video segment was being created. In some embodiments, video attribute determination module 152 can analyze the controller metadata to determine frequency and/or speed of player inputs as an attribute; the frequency and/or speed of player inputs can be used as an attribute indicative of the pace of the game play.

As a fourth example, the metadata can include a sentiment tag assigned by the developer to the portion of the game captured in the video segment (e.g., “joyful” or “scary” or other emotion). In some embodiments, video attribute determination module 152 can extract a sentiment tag from the metadata of the video segment, and the sentiment tag can be used as an attribute.

As a fifth example, the video data can be analyzed (e.g., using existing artificial intelligence (“AI”) models or other automated systems) to generate descriptions of image content and/or narration of the action. For example, an AI-generated narrative might state “character riding black horse through rainstorm” or “character walking through sunlit woods with tall grass.” In some embodiments, video attribute determination module 152 can incorporate or access a video analyzer to obtain a description or narration of video segment 205, and the description or narration (or keywords extracted therefrom) can be used as attributes.

As a sixth example, the video data can be analyzed (e.g., using existing AI models or other automated systems) to determine kinetic qualities of the video, such as how fast various objects in the scene and/or the virtual camera (point of view) are moving. In some embodiments, video attribute determination module 152 can incorporate or access a video analyzer to obtain attributes reflective of kinetic qualities of video segment 205.

As a seventh example, the video data can be analyzed (e.g., using existing AI models or other automated systems) to determine esthetic qualities of the video, such as lighting, color palette, sharpness or softness of focus, or the like, which may be suggestive of a mood or sentiment. In some embodiments, video attribute determination module 152 can incorporate or access a video analyzer to obtain attributes reflective of esthetic qualities of video segment 205.

It should be understood that these examples are illustrative and that video attribute determination module 152 can determine any number and combination of attributes of a video segment, including any combination of one or more of the above-described attributes and/or other attributes.

Track selection module 154 can include a query interface 212 that communicates with audio library 150, a scoring model 214, and decision logic 216. Responsive to receiving attributes of a video segment from video attribute determination module 152, query interface 212 can construct one or more queries to audio library 150 to identify candidate audio tracks that might be used to augment video segment 205. In some embodiments, all audio tracks in audio library 150 can be identified as candidates. However, for some users, audio library 150 may include a very large number of audio tracks, and it may be desirable to perform preliminary filtering to select a smaller number of candidate tracks. Accordingly, query interface 212 can construct a query based on one or more attributes of video segment 205, query audio library 150, and obtain a list of audio tracks that match (or “hit”) the query. For example, as described above, the attributes can include attributes related to pace of the game play such as frequency and/or speed of controller inputs, verbs in an AI-generated narration (e.g., running vs. walking), frame rate, kinetic qualities, etc. The particular attributes can be mapped to a tempo (e.g., beats per minute in a certain range), and a query can be constructed to identify audio tracks in audio library 150 that have corresponding tempos. In this manner, faster music can be selected for fast-paced scenes while slower music can be selected for slower-paced scenes. As another example, if a sentiment tag is available for the video segment (or a portion thereof), the sentiment tag can be used to select candidate tracks that are identified in audio library 150 as expressing a similar sentiment.

In some embodiments, query interface 212 can use information about the user to select candidate tracks from audio library 150, in addition to or instead of video attributes. For instance, if a listening history is available that identifies audio tracks (e.g., songs) that the user has listened to during gaming sessions or while playing a particular game or type of game, the listening history can be used to select candidate tracks. Listening history can also be used to construct other filters for selecting candidate tracks, such as selecting only tracks that the user listens to regularly or has listened to at least once (or some other minimum number of times) within a recent time period (e.g., in the last three, six, or twelve months). The candidate tracks in this example can include tracks in the user's listening history and/or other tracks, such as other tracks in the user's audio library that have the same artist or genre as tracks in the user's listening history.

Using any combination of any of the above and/or other techniques, query interface 212 can construct a list of candidate audio tracks for further evaluation by scoring model 214. Scoring model 214 can compute a score (e.g., a numerical value) for each candidate track based on comparing attributes of video segment 205 (“video attributes”) to properties of the candidate track (“audio properties”). In various embodiments, scoring model 214 can incorporate algorithmic scoring logic that receives as input a set of attributes of a video segment (“video attributes”) and a set of properties of an audio track (“audio properties”) and produces as output a similarity score. Video attributes can include any or all of the attributes described above and/or other attributes. Audio properties can include any property that can be defined for an audio track. Examples of audio properties include: genre; tempo (e.g., in beats per minute); dynamics (loudness or softness, dynamic range or contrast); instrumentation (e.g., what instruments are most prominent); lyrics (words that are sung or spoken in the track); and one or more tags indicating sentiment, mood, or other esthetic qualities of the track (e.g., based on acoustic analysis and/or editorial review). Audio properties for audio tracks in audio library 150 can be determined in advance and descriptors for the audio properties can be stored in audio library 150 or elsewhere (e.g., in a separate database as described below).

In some embodiments using algorithmic scoring logic, a given video attribute can be paired with a corresponding audio property, and a score component can be determined for each attribute/property pair. For instance, if a given video attribute and its corresponding audio property can be quantified on a linear scale, a score component can be defined based on the difference between the video attribute and its corresponding audio property. If a given video attribute and its corresponding audio property each have a finite and discrete set of possible values, a lookup table can be used to determine a scoring component for each pair of values. For example, a higher-valued (lower-valued) scoring component can be assigned to pairs that are more (less) similar (based on an editorial assessment), or a binary match/no-match determination can be used to determine a pairwise scoring component, and the pairwise scoring components thus defined can be stored in a lookup table. A final score can be determined, e.g., as a weighted sum of the scoring components. In some embodiments, scoring components can be used to define a logic tree or other algorithmic process that determines the weights or the final score. Other variations are also possible; for instance, instead of one-to-one correspondence between video attributes and audio properties, multiple video attributes can be combined into a compound video attribute and/or multiple audio properties can be combined into a compound audio property. A compound video attribute can be paired with an elementary audio property or a compound audio property and vice versa. In some embodiments, multiple compound attributes (or multiple compound properties) can be defined, and a given elementary video attribute (or audio property) can contribute to multiple compound attributes (or properties). In this manner, additional complexity can be added to the scoring model.

In some embodiments, scoring model 214 can incorporate a machine-learning model that has been trained to produce a similarity score given a set of video attributes and a set of audio properties. Any or all of the video attributes and audio properties described herein can be used as inputs to the machine-learning model, and the output of the machine-learning model can be a numerical value indicating a degree of similarity. The machine-learning model can be based on an artificial neural network and can incorporate enhancements such as feedback mechanisms, attention mechanisms, and so on. Training data for the machine-learning model can be obtained in various ways. For example, some players of video games publish edited clips of game-play content on internet-based platforms, and such videos may include soundtracks created or selected by the player. These edited clips can be analyzed to extract video attributes and audio properties, which can be used as training data examples. Training data can also include video segments that have been augmented with audio tracks (which can be randomly or arbitrarily selected) and assigned scores by human reviewers tasked with assessing how well the audio track matches the video content. The reviewer-assigned scores can be used to define ground-truth scores for training purposes. In some embodiments, the ground-truth scores can be determined by averaging scores from a panel of reviewers (e.g., to reduce bias due to individual musical tastes). Other techniques can also be used to obtain training data.

Regardless of particular implementation, the output of scoring model 214 can be a similarity score for each candidate track identified by query interface 212. Decision logic 216 can receive the similarity scores and rank the candidate audio tracks based at least in part on the similarity scores. In some embodiments, decision logic 216 can simply rank the audio tracks according to their similarity scores. In other embodiments, decision logic 216 can implement additional selection criteria. For example, decision logic 216 can use the similarity scores to select a small number (e.g., three to eight) of “finalist” audio tracks, then use other criteria to rank the finalists. Various ranking criteria can be used. For example, track selection module 154 may have access to information about the user's listening preferences, such as favorite genres or artists. Decision logic 216 can use these preferences to rank the finalists or adjust the scores of the finalists such that the user's favorites receive higher ranking. As another example, where a description of the video content is available, decision logic 216 can compare the description to lyrics of the finalists and rank the finalists or adjust similarity scores up or down based on similarity or dissimilarity between the video description and the lyrics. (As used herein, “lyrics” can include any words in an audio track, whether sung or spoken.) Regardless of the particular ranking criteria, the output of decision logic 216 can be identification of a single selected track or a ranked list of the finalists. Decision logic 216 can provide this output to mixer module 156.

Mixer module 156 can receive video segment 205 and the identification of selected track(s) from decision logic 216. For each selected track, mixer module 156 can obtain the selected audio track (e.g., selected track 220) from audio library 150 or from another source (e.g., a music server) and mix at least a portion of selected track 220 with video segment 205, thereby generating an augmented video segment 230. Mixing can include a variety of audio mixing operations. For example, mixer module 156 can simply replace the original audio component (game sounds) in the video segment with a portion (or all) of the selected audio track. Alternatively, mixer module 156 can combine the original audio component in the video segment with a portion (or all) of the selected track such that at least some of the game sounds can be heard. For instance, if the video segment includes spoken dialog (by in-game characters or the player(s)), mixer module 156 can selectively fade (lower the relative volume) of the selected audio track where it overlaps with the dialog, so that the dialog remains audible (and intelligible) over the selected audio track. As another example, mixer module 156 can detect acoustic breaks in the selected audio track (e.g., pauses in the music) and can align the acoustic breaks in time with the points in the video segment where dialog is present. In some embodiments, mixer module 156 can extend an acoustic break in the selected audio track so that the track resumes after the dialog has ended.

In some embodiments, mixer module 156 can also modify the selected audio track. For instance, mixer module 156 can select one or more portions of the audio track to include, which need not include the beginning or end of the audio track and which can include discontinuous portions of the audio track spliced together or repetitions of one portion of the audio track. Mixer module 156 can also modify the tempo of the audio track, speeding up or slowing down the tempo based on the pace of game play (e.g., frequency/speed of controller operation and/or kinetic attributes of the video images as described above).

In some embodiments, mixer module 156 can align specific time points in the selected audio track with specific time points in the video segment. For example, the video segment may include metadata such as a timestamp of a specific in-game event (e.g., when an opponent is finally vanquished, when an automobile race ends, or the like). Mixer module 156 can analyze the audio track to identify acoustic “peaks” in the track (e.g., based on volume and/or spectral analysis) and align the acoustic peaks with the timestamps of the in-game events.

In some embodiments, mixer module 156 can add other audio clips to the augmented video segment. For instance, lines of dialog from the video game or the players'chat can be extracted or copied from the audio component of a video segment and inserted at times other than when they originally occurred. As one example, where the video segment includes defeating an opponent, the opponent's last words could be replayed after the opponent is defeated. As another example, one player's words of encouragement to another player (e.g., “let's get this!” said at the beginning of an action sequence) could be repeated while the action sequence is in progress. If desired, mixer module 156 can also add audio clips from other sources, such as movies or TV; selection of sources or specific audio clips can be based on knowledge of user interests or preferences to further personalize the soundtrack of the augmented video segment.

It will be appreciated that system 200 is illustrative and that variations and modifications are possible. For example, for a given video segment 205, scoring model 214 can be applied to every track in the user's audio library 150, and query interface 212 can be omitted. Scoring models can be modified as desired and can use any combination of video attributes and audio properties. Multiple scoring models operating on different subsets of video attributes and audio properties can be implemented, and scores produced from different models can be combined, e.g., using logic trees, mixture of experts, or other techniques. Audio properties can be provided by the service that hosts audio library 150, or system 200 can be modified to include a component that determines properties of audio tracks. In some embodiments, a database of audio properties of various tracks can be maintained independently of audio library 150, e.g., by the operator of system 200 or by a third party. System 200 can communicate with audio library 150 to obtain audio track identification, then communicate with the database of audio properties to retrieve audio properties for the identified audio track(s).

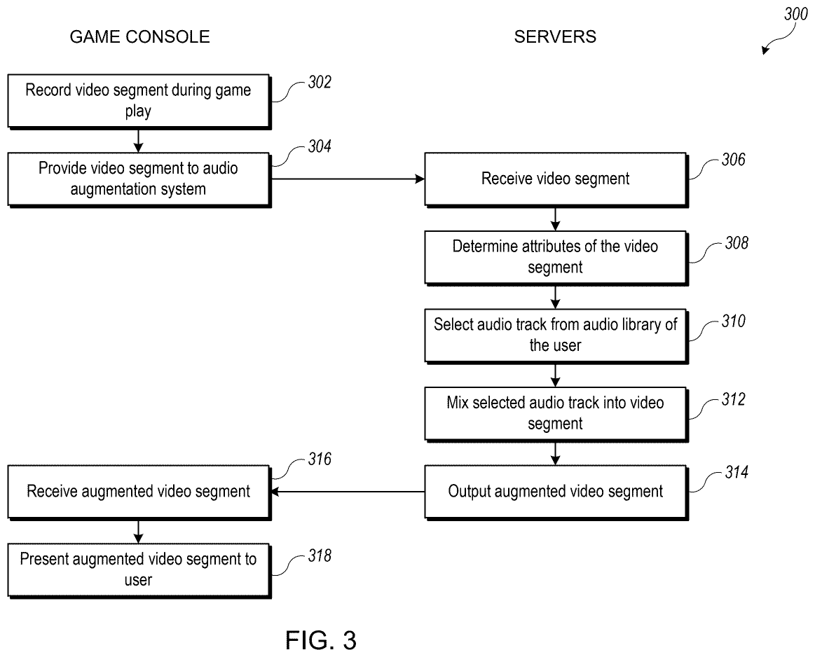

FIG. 3 shows a flow diagram of a process 300 for generating an augmented video segment according to some embodiments. Process 300 can be implemented using system 200 of FIG. 2. In this example, system 200 is implemented in a server system that communicates with a game console, such as servers 120 communicating with game console 110 as shown in FIG. 1.

At block 302, game console 110 can record a video segment during game play. As described above, recording of a video segment can happen automatically (e.g., in association with particular in-game events) or in response to user (player) input. At block 304, game console 110 can provide the recorded video segment to servers 120. For instance, game console 110 can transmit the recorded video segment to servers 120 in response to user input requesting creation of an augmented video segment.

At block 306, servers 120 can receive the video segment from game console 110. At block 308, servers 120 can determine attributes of the video segment. For instance, servers 120 can implement video attribute determination module 152 as described above. At block 310, servers 120 can select an audio track from an audio library of the user based on similarity of the attributes of the video segment and properties of the audio tracks. For instance, servers 120 can implement track selection module 154 as described above.

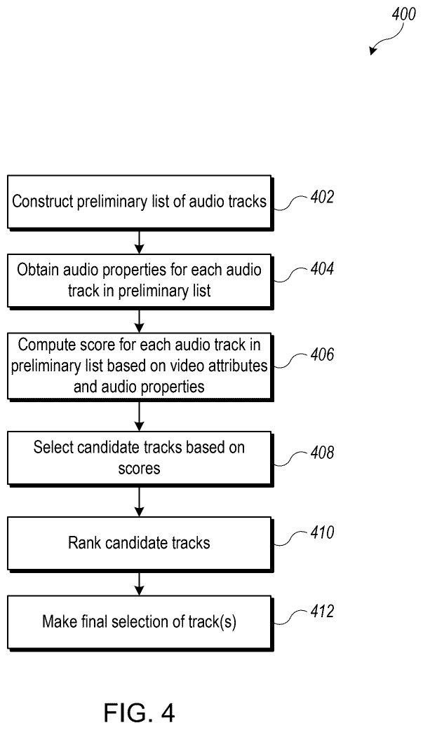

FIG. 4 is a flow diagram showing additional details of audio track selection at block 308 according to some embodiments. At block 402, a preliminary list of audio tracks can be constructed. For example, servers 120 can communicate with a music streaming service to which the user subscribes to obtain a list of audio tracks in the user's audio library. The list may include attributes of the audio tracks. In some embodiments, a complete list of all audio tracks in the user's audio library can be obtained. However, such a list may be quite large, and accordingly servers 120 can construct a preliminary list of audio tracks by communicating with the music streaming service to obtain a list of tracks from the user's library that satisfy a more specific query. For instance, as described above, servers 120 can implement query interface 212 as described above to formulate one or more queries to the music streaming service (or other host of audio library 150) and construct a preliminary list based on responses from the music streaming service. In another implementation, servers 120 can obtain a complete list of all audio tracks in the user's audio library from the music streaming service, then query a different source to filter the list. For instance, as described above, servers 120 or a third party may maintain a database of properties of audio tracks, and that database can be queried (e.g., using an appropriate implementation of query interface 212) to determine which tracks in the user's audio library have properties matching a particular query. Thus, the preliminary list constructed at block 402 can include some or all of the audio tracks in the user's audio library. As noted above, it is assumed that the user's audio library is personalized to the user and reflects music and/or other audio tracks that the user has chosen to include in the library. In general, it is expected that different users will have different audio libraries (even with the same streaming service), and thus the preliminary list of audio tracks is personalized to a particular user.

At block 404, audio properties for each audio track in the preliminary list can be obtained. For example, servers 120 can query the music streaming service and/or a separate database to obtain audio properties such as any or all of the audio properties described above. At block 406, servers 120 can compute a score for each audio track in the preliminary list, based on similarities between the video attributes of the video segment and the audio properties of the audio track. For example, servers 120 can implement scoring model 214 as described above. At block 408, servers 120 can select one or more candidate tracks based on the scores computed at block 406; at block 410, servers 120 can rank the candidate tracks based on the scores; and at block 412, servers 120 can select one or more tracks (e.g., the highest-ranking track(s)). For example, servers 120 can implement decision logic 216 as described above to execute blocks 408, 410, and 412. In some embodiments, one track is selected at block 412. In other embodiments, a small number (e.g., two, three, or six) of “finalist” tracks can be selected to allow the user to make a final selection as described below.

Referring again to FIG. 3, at block 312, the selected audio track can be mixed into the video segment to create an augmented video segment that includes a personalized soundtrack that was selected automatically from a user's audio library For instance, servers 120 can implement mixer module 156 described above. In some embodiments where multiple finalist tracks are selected, block 312 can include creating a different augmented video segment using each finalist track. The video content of the different augmented video segments can be the same, but the audio would be different. At block 314, the augmented video segment (or multiple augmented video segments) can be output to game console 110.

At block 316, game console 110 can receive the augmented video segment(s), and at block 318, game console 110 can present the augmented video segment to the user. In various embodiments, the user can determine the disposition of the augmented video segment. For instance, the user can choose to save the augmented video segment, share the augmented video segment with friends on a social network or with any other service that supports sharing of media content, or delete the augmented video segment. In some embodiments, the user can choose whether to replace the original recorded video segment with the augmented version or keep both versions.

Process 300 illustrates one possible division of operations between game console 110 and servers 120. It should be understood that other configurations are possible. For instance, determining attributes of the video segment and mixing of a selected audio track with the video segment can be performed on game console 110. In this configuration, game console 110 can send just the video attributes to servers 120. In addition, game console 110 rather than servers 120 can retrieve the selected audio track from the user's audio library.

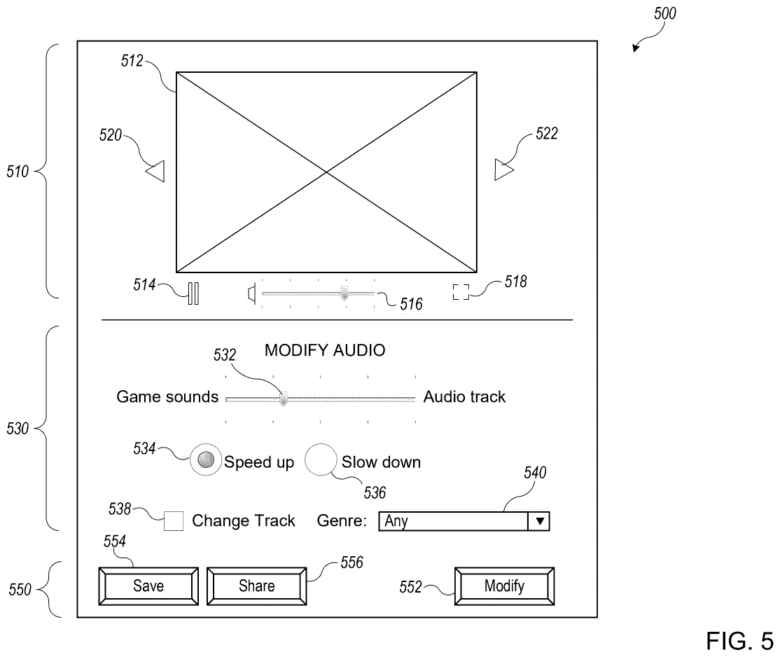

In some embodiments, process 300 can be incorporated into an interactive process that allows users to generate and further customize augmented video segments. FIG. 5 shows a graphical user interface 500 according to some embodiments. Graphical user interface 500 can be displayed, e.g., by game controller 110 on screen 132. Graphical user interface 500 can allow a user to view and provide feedback on automatically generated augmented video segments. Graphical user interface 500 can include a video viewer 510, a feedback interface 530, and action buttons 550.

Video viewer 510 can include a playback area 512 in which video segments can be played; playback controls such as a play/pause button 514, a volume control 516, and a full-screen-mode control 518; and segment selectors 520 (previous segment) and 522 (next segment). By operating controls of video viewer 510, a user can watch video segments, including augmented video segments with personalized soundtracks created using automated techniques as described herein.

Feedback interface 530 can allow the user to specify modifications to be made to an augmented video segment currently being presented in playback area 512. For example, the user can operate a slider 532 to indicate a desired adjustment to the relative volumes of the game sounds and the added audio track. In addition or instead, the user can operate radio buttons 534, 536 to indicate a desired change of tempo to better match the game play. In addition or instead, the user can select check box 538 to request a version of the augmented video segment made using a different audio track; drop-down menu 540 can allow the user to select a genre. Other options and controls can also be provided. For instance, a slider can be provided to allow the user to indicate a degree of tempo adjustment desired.

Once the user has entered feedback into feedback interface 530, the user can select “Modify” button 552 to generate a modified version of the augmented video segment based on the user's feedback, and the modified version can be presented in playback area 512. If the user is satisfied with the augmented video segment currently being presented in playback area 512, the user can select “Save” button 554 to save the augmented video segment or “Share” button 556 to share the augmented video segment with others.

It should be understood that graphical user interface 500 is illustrative and can be modified. Different interface elements can be provided (e.g., to specify different types of audio modification), and elements can be arranged as desired.

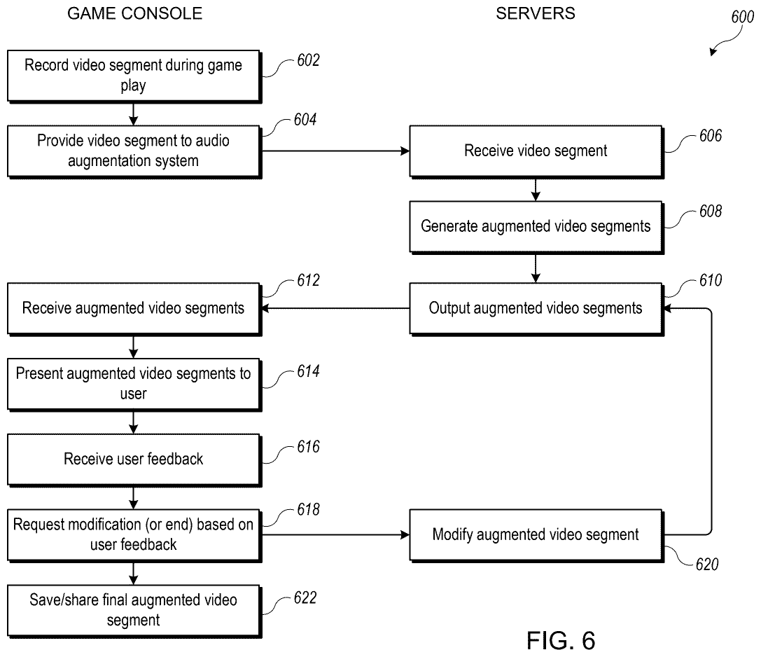

Graphical user interface 500 can support an interactive process for generating an augmented video segment with a personalized soundtrack. FIG. 6 shows a flow diagram of an interactive process 600 for generating an augmented video segment with a personalized soundtrack according to some embodiments. Process 600 is similar to process 300 in most respects and can also be implemented using system 200 of FIG. 2. In this example, system 200 is implemented in a server system that communicates with a gaming console, such as servers 120 communicating with game console 110 as shown in FIG. 1.

At block 602, game console 110 can record a video segment during game play. As described above, recording of a video segment can happen automatically in association with particular in-game events or in response to user input. At block 604, game console 110 can provide the recorded video segment to servers 120. For instance, game console 110 can transmit the recorded video segment to servers 120 in response to user input requesting creation of an augmented video segment.

At block 606, servers 120 can receive the video segment from game console 110. At block 608, servers 120 can generate augmented video segments. For example, servers 120 can perform blocks 306-312 of process 300 as described above. In this example, servers 120 can generate multiple augmented video segments using multiple finalist tracks as described above. At block 610, the augmented video segments can be output to game console 110.

At block 612, game console 110 can receive the augmented video segments. At block 614, game console 110 can present the augmented video segments to the user. For example, the augmented video segments can be presented in playback area 512 of graphical user interface 500, and the user can control the playback using playback controls of video viewer 510. In some embodiments, the user can easily switch between different augmented video segments, e.g., using segment selectors 520 and 522. In this manner, the user may compare different augmented video segments generated using the same game-play content. At block 616, the user may provide feedback on one or more of the augmented video segments. For example, while viewing a particular augmented video segment in playback area 512 of graphical user interface 500, the user can operate controls in feedback interface 530 to indicate the desired modifications to that video segment, then operate Modify button 552 to request that the modifications be made. Or, if the user is satisfied with one of the augmented video segments, the user can operate Save button 554 or Share button 556.

At block 618, if the user operates Modify button 552, game console 110 can send a request to servers 120 to generate a modified version of the augmented video segment that the user requested to modify. The request can include feedback data representing the user's feedback. In response, at block 620, servers 120 can generate the modified version in accordance with the feedback data and return to block 610 to output the modified version to game console 110. In this manner, an iterative cycle of user feedback and modifications to the video can be performed until the user is satisfied with the result.

If, at block 618, the user operates Save button 554 or Share button 556, then at block 622, game console 622 can save or share the augmented video segment in its current form. Augmented video segments can be saved locally on game console 110 and/or in remote storage (e.g., cloud storage associated with servers 120 or other network storage). Sharing of an augmented video segment can include transmitting the segment to one or more recipients, which can include specific users, social media accounts, or other locations where others can access video content.

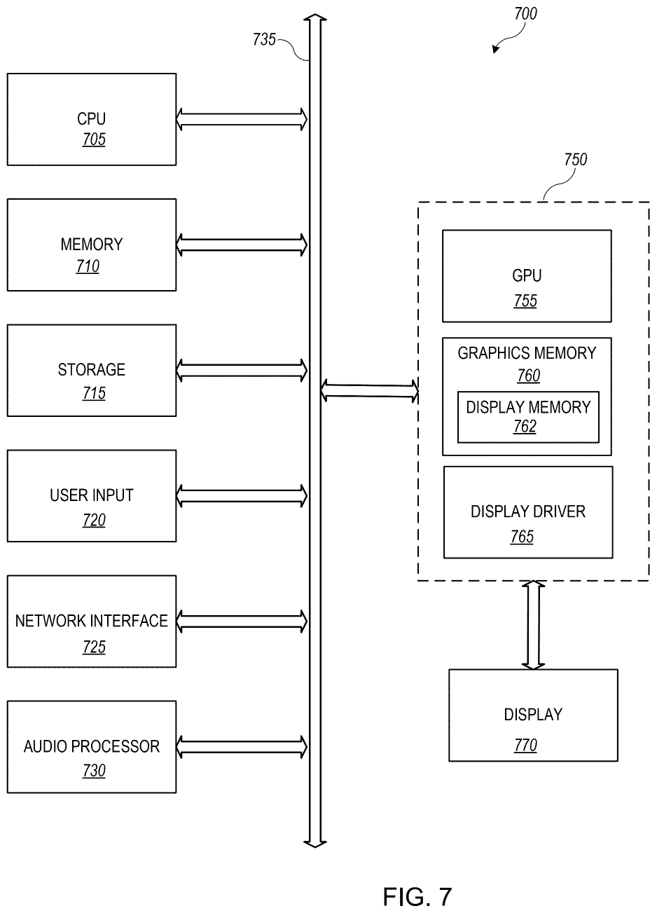

FIG. 7 shows a simplified block diagram of a hardware system suitable for implementing a computer system 700 according to some embodiments. The computer system 700 can be, for example, a video game system, a personal computer (e.g., laptop or desktop computer), a handheld computer (e.g., a tablet or smartphone), a server computer, or other type of computer system. Computer system 700 can include a central processing unit (CPU) 705 capable of running software applications and optionally an operating system. CPU 705 can include one or more homogeneous or heterogeneous processing cores implemented in one or more integrated circuits. In some embodiments, CPU 705 can be implemented using one or more general-purpose microprocessors and/or microprocessors whose architectures are specifically adapted for highly parallel and computationally intensive applications, such as media and interactive entertainment applications. Memory 710 can store applications and data for use by CPU 705 and can include any combination of volatile and/or non-volatile memory components (e.g., DRAM, SRAM, etc.). Storage subsystem 715 can provide non-volatile storage for applications and data and may include various computer readable storage media such as fixed disk drives, removable disk drives, flash memory devices, and CD, DVD, Blu-ray, HD-DVD, or other optical storage devices. User input devices 720 can include devices that communicate user inputs from one or more users to computer system 700. Examples of user input devices 720 can include keyboards, mice, thumbsticks, touch pads, touch screens, still or video cameras, and/or microphones. In some embodiments, some or all of user input devices 720 can be incorporated into a handheld controller (e.g., controller 112 of FIG. 1) that communicates with other components of computer system 700 via a wired or wireless connection. Network interface 725 allows computer system 700 to communicate with other computer systems via an electronic communications network. Network interface 725 can include hardware and associated software to support wired and/or wireless communication over local area networks and/or wide area networks such as the Internet. An audio processor 730 can be adapted to generate analog or digital audio output signals from instructions and/or data provided by CPU 705, memory 710, and/or storage subsystem 715. The components of computer system 700, including CPU 705, memory 710, storage subsystem 715, user input devices 720, network interface 725, and audio processor 730 can be connected via a data bus 735.

A graphics subsystem 750 can also be connected to data bus 735 and thereby to other components of computer system 700. Graphics subsystem 750 can include a graphics processing unit (GPU) 755, a graphics memory 760, and a display driver 765. GPU 755 can operate as a co-processor to CPU 705 to accelerate operations associated with generating images for display. For example, GPU 755 can support 3D rendering operations to generate pixel data for output images from instructions and data defining the geometry, lighting, shading, texturing, motion, and/or camera parameters for a scene, for instance by executing shader programs and/or other rendering programs or operations. Graphics memory 760 can include a display memory 762 (e.g., a frame buffer) used for storing pixel data for each pixel of an output image. Graphics memory 760 (or portions thereof) can be integrated in the same device as GPU 755, connected as a separate device to GPU 755, and/or implemented within memory 710. Pixel data can be provided to display memory 762 directly from CPU 705. Additionally or instead, CPU 705 can provide GPU 755 with data and/or instructions defining the desired output images, from which GPU 755 can generate pixel data for one or more output images and write the pixel data to display memory 762. Display driver 765 can periodically output pixel data for an image from display memory 762 to a display device 770. Display device 770 can be any device capable of displaying visual information in response to a signal from display driver 765 that incorporates the pixel data; examples include CRT, LCD, plasma, LED, and OLED displays. Depending on implementation, display driver 765 can provide display device 770 with an analog or digital signal.

To implement system 200 or portions thereof, computer system 700 can store program code implementing any or all of the modules described above. Such program code can be stored in storage subsystem 715 and/or memory 710 and executed using CPU 705. A graphical user interface can be provided using a combination of display 770 and user input received via user input devices 720; CPU 705 can execute program code to display the interface and process user input.

While the invention has been described with reference to specific embodiments, those skilled in the art will appreciate that variations and modifications are possible. For instance, in some embodiments, a system that generates augmented video content can learn from user feedback to identify genres or artists that the user tends to prefer. As another example, a video segment can be subdivided into sub-segments and different audio tracks can be selected for each sub-segment. Cross-fading or similar audio mixing techniques can be used to transition from one track to the next at a sub-segment boundary.

As noted above, selection of audio tracks for augmented videos is personalized for each user depending on the content of that user's audio library. Selection of audio tracks may also depend on the user's listening history, as in examples described above. Thus, two different users playing an online game together may each record the same video segment and obtain different augmented video segments, depending on the content of their respective audio libraries. In some embodiments, a single “joint” video segment can be created for two (or more) users playing an online game together. For instance, the augmented video creation system can be instructed to identify audio tracks that are in the respective audio libraries of both users. Alternatively, given an audio track that is in one user's library but not in the other user's library, the system can estimate a probability that the other user will like the track based on tracks that are in the other user's library. A track that is in one user's library and has a high probability of being liked by the other user can be selected for the joint video segment.

In some embodiments, the tracks can be musical tracks, such as songs. Other types of audio content can also be used, including recorded clips of spoken-word audio, such as audio excerpts from movies, TV shows, audiobooks, or podcasts.

In some embodiments, the user's decisions to save and/or share particular augmented video segments with personalized soundtracks can be indicative of the types of audio tracks the user likes to listen to while playing video games. Accordingly, a user's history related to augmented video segments with personalized soundtracks can be used to train an AI model or agent to make real-time audio track selections from the user's audio library to accompany the user's game play. The selection can be based on the user's preferences as well as a match between attributes of the game being played and/or the user's playing style (e.g., frequency/speed of controller inputs) and tracks in the audio library. It should be understood that for real-time track selection, it may not be feasible to align specific elements of a selected audio track with specific game-play events; however, similarity scores or other techniques described herein can be used to select a track from the user's audio library that is similar to the general mood, sentiment, or intensity of action of the user's current game play.

All processes described herein are also illustrative and can be modified. Operations can be performed in a different order from that described, to the extent that logic permits; operations described above may be omitted or combined; and operations not expressly described above may be added.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code for execution by the processor. Various blocks might or might not be reconfigurable depending on how the initial configuration is obtained. Embodiments of the present invention can be realized in a variety of apparatus including electronic devices implemented using a combination of circuitry and software.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may include an internal storage medium of a compatible electronic device and/or external storage media readable by the electronic device that can execute the code. In some instances, program code can be supplied to the electronic device via Internet download or other transmission paths.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein. A network may include both wired and wireless connections, including optical links. Many other examples are possible and will be apparent to those skilled in the art in light of this disclosure.

User interfaces for a given device can be implemented using various combinations of components. For instance, a graphical user interface may present a menu of options from which the user can select by operating an input device (e.g., mouse, thumbstick, buttons, etc.). A speech-based interface can be responsive to specific control words or phrases that the user may speak to change settings or invoke device functions. Some user interfaces can be implemented using switches, toggles, buttons, dials, or the like that the user can set to a desired position to control a device setting or function; feedback to the user can be provided via indicator lights, haptics, sounds, or other perceptual stimuli.

All numerical values and ranges provided herein are illustrative and may be modified. Unless otherwise indicated, drawings should be understood as schematic and not to scale. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Terms such as “approximately” or “substantially” should be understood to reflect manufacturing tolerance or expectations in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

It should also be understood that audio libraries and/or video segments may contain content that is protected by copyright. It is assumed that any use of such content would be in a manner consistent with applicable copyright restrictions.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, although the invention has been described with respect to specific embodiments, it will be appreciated that the invention is intended to cover all modifications and equivalents within the scope of the following claims.

What is claimed is:

1. A computer-implemented method comprising:
receiving a recorded video segment of game play by a user of a video game system;
determining one or more attributes of the recorded video segment;
selecting, from a personal audio library associated with the user, an audio track to accompany the recorded video segment, wherein each audio track in the personal audio library has an associated set of properties and wherein the selection of the audio track is based at least in part on a similarity between the one or more attributes of the recorded video segment and the set of properties of the audio tracks; and
mixing at least a portion of the selected audio track into the recorded video segment to produce an augmented video segment.

2. The method of claim 1 wherein:
determining the one or more attributes of the recorded video segment includes determining a pace of the game play in the recorded video segment; and
selecting the audio track includes identifying an audio track in the personal audio library that has a tempo that corresponds to the pace.

3. The method of claim 1 wherein:
determining the one or more attributes of the recorded video segment includes inferring, from an automated analysis of video data in the recorded video segment, a sentiment associated with the recorded video segment; and
selecting the audio track includes identifying an audio track in the personal audio library that has a corresponding sentiment.

4. The method of claim 1 wherein:
determining the one or more attributes of the recorded video segment includes generating, using a video analysis tool, a narration describing video content of the recorded video segment; and
selecting the audio track includes identifying an audio track in the personal audio library that has lyrics with similarity to the narration.

5. The method of claim 1 wherein selecting the audio track is performed using a machine-learning model that has been trained to generate a similarity score from a set of attributes of a video segment and a set of properties of an audio track.

6. The method of claim 1 wherein mixing at least a portion of the selected audio track into the recorded video segment includes combining the portion of the selected audio track with a game-play audio track of the recorded video segment.

7. The method of claim 1 wherein mixing at least a portion of the selected audio track into the recorded video segment includes modifying the portion of the selected audio track to align in time with an event in the recorded video segment.

8. A system comprising:
a memory; and
a processor coupled to the memory and configured to:
receive a recorded video segment of game play by a user of a video game system;
determine one or more attributes of the recorded video segment;
select, from a personal audio library associated with the user, an audio track to accompany the recorded video segment, wherein each audio track in the personal audio library has an associated set of properties and wherein the selection of the audio track is based at least in part on a similarity between the one or more attributes of the recorded video segment and the set of properties of the audio tracks; and
mix at least a portion of the selected audio track into the recorded video segment to produce an augmented video segment.

9. The system of claim 8 wherein the one or more attributes of the recorded video segment include one or more of:
a keyword associated with a title of a game being played in the recorded video segment;
a frame rate of the recorded video segment;
a frequency or speed of player inputs to a controller during the game play;
a sentiment tag included in metadata of the recorded video segment;
an automatically-generated description or narration of the recorded video segment;
a kinetic quality of the recorded video segment; or
an esthetic quality of the recorded video segment.

10. The system of claim 8 wherein the one or more properties of the audio track include one or more of:
a genre of the audio track;
a tempo of the audio track;
dynamics of the audio track;
a prominent instrument in the audio track;
a lyric in the audio track; or
a tag indicating an esthetic quality of the audio track.

11. The system of claim 8 wherein the personal audio library is maintained at a music streaming service and the processor is further configured to communicate with the music streaming service to obtain a list of audio tracks in the personal audio library of the user.

12. The system of claim 8 wherein the processor is further configured to determine the associated set of properties for one or more audio tracks from the personal audio library by accessing a database of properties of audio tracks.

13. The system of claim 8 wherein the recorded video segment includes audio data representing in-game sound and wherein the processor is further configured such that mixing at least a portion of the selected audio track into the recorded video segment to produce an augmented video segment includes combining the portion of the selected audio track with the audio data from the recorded video segment.

14. The system of claim 8 wherein the processor is further configured such that mixing at least a portion of the selected audio track into the recorded video segment to produce an augmented video segment includes selecting a particular portion of the selected audio track to be mixed with an audio component of the recorded video segment.

15. A computer-readable storage medium having stored therein program code instructions that, when executed by a processor in a computer system, cause the processor to perform a method comprising:
receiving a recorded video segment of game play by a user of a video game system;
determining one or more attributes of the recorded video segment;
selecting, from a personal audio library associated with the user, an audio track to accompany the recorded video segment, wherein each audio track in the personal audio library has an associated set of properties and wherein the selection of the audio track is based at least in part on a similarity between the one or more attributes of the recorded video segment and the set of properties of the audio tracks; and
mixing at least a portion of the selected audio track into the recorded video segment to produce an augmented video segment.

16. The computer-readable storage medium of claim 15 wherein the one or more attributes of the recorded video segment include one or more of:
a keyword associated with a title of a game being played in the recorded video segment;
a frame rate of the recorded video segment;
a frequency or speed of player inputs to a controller during the game play;
a sentiment tag included in metadata of the recorded video segment;
an automatically-generated description or narration of the recorded video segment;
a kinetic quality of the recorded video segment; or
an esthetic quality of the recorded video segment.

17. The computer-readable storage medium of claim 15 wherein the one or more properties of the audio track include one or more of:
a genre of the audio track;
a tempo of the audio track;
dynamics of the audio track;
a prominent instrument in the audio track;
a lyric in the audio track; or
a tag indicating an esthetic quality of the audio track.

18. The computer-readable storage medium of claim 15 wherein selecting the audio track to accompany the recorded video segment includes:
constructing a preliminary list of audio tracks from the personal audio library;
obtaining the associated set of properties for each audio track in the preliminary list of audio tracks;
computing a score for each audio track in the preliminary list of audio tracks, wherein the score is based on a comparison between the one or more attributes of the recorded video segment and the set of properties for the audio track;
selecting, from the preliminary list of audio tracks, a set of candidate tracks based on the scores;
ranking the candidate tracks in the set of candidate tracks; and
making a final selection of the audio track to accompany the recorded video segment based on the ranking of the candidate tracks.

19. The computer-readable storage medium of claim 15 wherein the recorded video segment includes audio data representing in-game sound and wherein mixing at least a portion of the selected audio track into the recorded video segment to produce an augmented video segment includes combining the portion of the selected audio track with the audio data from the recorded video segment.

20. The computer-readable storage medium of claim 15 wherein mixing at least a portion of the selected audio track into the recorded video segment to produce an augmented video segment includes:
determining, based on one or more of the attributes of the recorded video segment, a pace of game play; and
adjusting a tempo of the selected audio track based on the pace of game play.
